(19) United States
(12) Patent Application Publication
(10) Pub. No.: US 2014/0046847 A1
(43) Pub. Date: Feb. 13, 2014

(54) ACCOUNTS PAYABLE SYSTEM WITH USER CONTROL

(71) Applicants: Mondo Jacobs, Foster City, CA (US); Richard Eastley, Foster City, CA (US); Dave Meaney, Foster City, CA (US)

(72) Inventors: Mondo Jacobs, Foster City, CA (US); Richard Eastley, Foster City, CA (US); Dave Meaney, Foster City, CA (US)

(21) Appl. No.: 13/826,121

(22) Filed: Mar. 14, 2013

Related U.S. Application Data
(60) Provisional application No. 61/680,615, filed on Aug. 7, 2012.

(51) Int. Cl. G06Q 20/40

(52) U.S. Cl. CPC G06Q 20/405
USPC 705/44

(57) ABSTRACT

A method is disclosed. The method includes receiving a payment instruction file. In some cases, the payment instruction file contains a plurality of payment instructions with conditional control data to pay one or more suppliers. The conditional control data controls execution of the payment instructions. The method further includes receiving a plurality of transaction messages corresponding to the plurality of payment instructions, respectively, where each transaction message in the plurality of transaction messages is conducted using one or more payment accounts. If transaction data in a transaction message in the plurality of transaction messages does not satisfy the conditional control data, then the transaction message is declined by a server computer. If transaction data in the transaction message in the plurality of transaction messages does satisfy the conditional control data, then the transaction message is approved by the server computer.

### CROSS-REFERENCE TO RELATED APPLICATIONS

This application is a non-provisional of and claims priority to U.S. Provisional Application No. 61/680,615 filed on Aug. 7, 2012, which is herein incorporated by reference in its entirety for all purposes.

### BACKGROUND

To run a business, raw materials, finished goods, and supplies are needed by the business. Additionally, the business needs various service providers. Whether goods or services are provided to the business, each such supplier must be paid for those goods and services provided to the business. Each supplier sends an invoice to the business in order to be paid for the goods and service that it delivers to the business. The invoice is the means by which the supplier is compensated by the business for the goods and services that the business has received or will receive. After receipt of an invoice by the business, a supplier who sent the invoice will typically wait a number of days before being paid by the business to which goods and/or services were provided. The business typically pays its supplier through an accounts payable system. The payment of the supplier by the business can be by cash, check, or via a payment on an account that was issued to the business by an issuer such as the business's bank. It may be particularly advantageous to pay each supplier on an account. These advantages include incentives and rebates from the issuer who finances the business' payments to its suppliers, the lower cost to the business of electronic payment processing as opposed to processing payments by check, the ‘float’ advantage to the business of stalling the actual out flow of cash by use of credit so in paying its suppliers so as to maximize working capital, etc.

A business will typically receive numerous invoices from its suppliers for goods and services that have already been provided to the business by its respective suppliers. Periodically, the business will identify those invoices it wishes to pay from among those invoices it has received. To pay each invoice, a collaborative work flow may be required throughout the business's organizations (e.g., treasury, finance, accounts payable, audit and compliance, information technology, procurement, etc.) to secure and control approval for payment.

Once a set of invoices to be paid has been identified, a method of payment for each invoice is further determined. In the case of those invoices that are to be paid upon an account issued to the business by an issuer, a batch process is typically used. The account upon which the business pays its account payable is often referred to as a commercial account, or alternatively an account corresponding to a ‘commercial card’. The commercial account can have funds on deposit, or it can be a revolving credit account, or a one-time-only use credit account (e.g., spot credit).

In the accounts payable batch process, a group of invoices (e.g., a batch of invoices) is identified by the business for payment by way of processing through the business's accounts payment system. An issuer of the business's commercial account will receive the batch of invoices. Daily, the business may send one (1) batch of invoices to its commercial account issuer. The issuer will then transfer funds to each supplier for its corresponding invoice in the batch. In the case where the issuer is financing the accounts payable, the business will be financially responsible for depositing funds with the issuer sufficient to pay the issuer for payments made on the account to the business's suppliers that correspond to the batch of invoices, plus services charges, interest, and penalties. The issuer may provide rewards, incentives, and rebates to the business for its loyalty to the issuer in agreeing to allow the issuer to finance the business' accounts payables.

In some cases, during the accounts payable process, the supplier who is being paid will have possession of the account number of the buyer and the supplier will use this account number to initiate payment. In some cases, the supplier may inadvertently or even purposely charge an amount on the account number that is different than the amount authorized by the buyer. This can be a significant problem, as it can cause reconciliation problems. For example, if the supplier charges an amount on a buyer's credit or debit card account that is more or less than the amount that the buyer expects to pay, then this will result in a significant number of additional communications and transactions to fix the transaction.

Embodiments of the invention address this and other problems, individually and collectively.

### SUMMARY

Embodiments of the invention are directed to automated accounts payable systems that incorporate automated controls on payment account (e.g., payment card account) processing.

One embodiment of the invention is directed to a method. The method comprises receiving a payment instruction file. The payment instruction file contains one or more payment instructions (e.g., a plurality of payment instructions) to pay one or more suppliers. Conditional control data for the one or more payment instructions may be present in the payment instruction file or may be sent in a separate communication. The conditional control data controls execution of the payment instructions. The method further comprises receiving one or more transaction messages (e.g., a plurality of transaction messages) corresponding to the one or more payment instructions, respectively, where each transaction message in the one or more transaction messages is conducted using one or more payment accounts. The one or more payment accounts can be held by one or more issuers. However, in some embodiments, there is only one issuer associated with one buyer. If transaction data in a transaction message in the one or more transaction messages does not satisfy the conditional control data for the payment instruction associated with the transaction message, then the transaction message is declined by a server computer. If transaction data in the transaction message in the one or more transaction messages does satisfy the conditional control data for the payment instruction associated with the transaction message, then the transaction message is approved by the server computer.

Another embodiment of the invention is directed to a server computer comprising: a processor, and a computer readable medium coupled to the processor, the computer readable medium comprising code for causing the processor to execute the above-described method as well as other methods.

Another embodiment of the invention is directed to a method. The method comprises receiving, by a supplier device, a plurality of remittance messages from a server computer corresponding to a plurality of payment instructions from a buyer. The method also comprises transmitting, by the supplier device, a plurality of transaction messages corresponding to the plurality of payment instructions to the server computer, respectively, wherein each transaction message in the plurality of transaction messages is conducted using one or more payment accounts. The one or more payment accounts may be held by one or more issuers. If transaction data in a transaction message in the plurality of transaction messages does not satisfy the conditional control data for the payment instruction associated with the transaction message, then the transaction message is declined by the server computer. If transaction data in the transaction message in the plurality of transaction messages does satisfy the conditional control data for the payment instruction associated with the transaction message, then the transaction message is approved by the server computer for further processing.

Another embodiment of the invention is directed to a supplier device comprising a processor and a computer readable medium coupled to the processor. The computer readable medium comprises code, executable by the processor to implement the above-described method, and other methods.

These and other embodiments of the invention are described in further detail below.

### BRIEF DESCRIPTION OF THE DRAWINGS

FIG. 1 shows a block diagram of an exemplary system according to an embodiment of the invention.

FIG. 2 shows a block diagram of an exemplary payables processor system according to an embodiment of the invention.

FIG. 3 shows a block diagram of an exemplary conditional control system according to an embodiment of the invention.

FIG. 4 shows a flowchart showing different ways to enroll in a conditional control system.

FIG. 5 shows a flowchart for processing a buyer's instruction file according to an embodiment of the invention.

FIG. 6 shows a flowchart for processing a buyer's instruction file according to an embodiment of the invention.

FIG. 7 shows a flowchart of a supplier's interaction with the payables processor system after receiving a remittance notification.

FIG. 8 shows a flowchart of the payables processor system after a payment instruction expires according to an embodiment of the invention.

FIG. 9 shows a flowchart of the payables processor system after a payment instruction expires according to an embodiment of the invention.

FIG. 10 shows a block diagram of a computer apparatus with different subsystems or components.

FIG. 11 shows a screenshot that can show a buyer the types of supplier data that can be viewed.

FIG. 12 shows an exemplary remittance notification.

### DETAILED DESCRIPTION

Embodiments of the invention may comprise an accounts payable system that comprises a conditional control system that synchronizes with a payables processor system to automatically execute payment instructions and block transactions that are not authorized by the buyer. In embodiments of the invention, an account may be registered and the user (e.g., a buyer) may define a blocking parameter for a payables transaction. This blocking parameter may be an example of conditional control data. For example, the blocking parameter (or conditional control data) may be a rule such as “authorize only one transaction that has a transaction amount of $500.23 for card account 2345678.”

In an embodiment, the initial setting of a card account to be used in an accounts payable system may be to block all transactions. A payables processor system may then set the desired controls based on conditional control data in a payment instruction file received from the buyer's device. After receiving a remittance notification, a supplier that supplies goods or services to the buyer may initiate an authorization request using a supplier device. The supplier device may transmit an authorization request to a payment processing network that processes credit and debit card transactions. The payment processing network may then contact a conditional control system which contains the conditional control data to determine if the authorization request message should be passed on to the issuer for final authorization approval. If the transaction data in the authorization request message satisfies the conditional control data, then the authorization request message may be forwarded to the issuer. If the transaction data does not satisfy the conditional control data, then the authorization request message may be denied and authorization response may be transmitted back to the supplier device.

Prior to discussing embodiments of the invention, a further description of some terms may be helpful in understanding embodiments of the invention.

A “payment instruction file” can include an electronic communication that contains one or more payment instructions and optionally conditional control data. In some embodiments, there can be more than 5, 10, 15 or 20 payment instructions per payment instruction file. A payment instruction file according to an embodiment of the invention may include multiple payment instructions to a single supplier, or multiple payment instructions to multiple suppliers. The payment instruction file can be in any suitable data format including a proprietary format, an EDI (e.g., EDI 820) format, etc. An EDI file format is an Electronic Data Interchange format, which is a computer-to-computer interchange of strictly formatted messages that represent documents other than monetary instruments. In embodiments of the invention, a payment instruction file is typically transmitted by a buyer device operated by a buyer. Suitable file connectivity options may include SFTP, FTPS, HTTPS, and AS2.

A “payment instruction” can be an instruction to pay a particular supplier a specified amount. The payment could be for a particular good or service that has already been provided by the supplier, or is to be provided to the supplier in the future. A payment instruction may include a supplier name, a purchase amount, and a time or time period in which the payment transaction is to be executed.

A “buyer” may be a purchaser of goods or services. It may be an issuer's participating commercial payment account (e.g., payment card account) end-client that subscribes to the service offered by the payables processor system, and submits accounts payable files to it.

A “buyer device” may include one or more devices operated by a buyer. It may be used to provide payment instruction files to a payables processor system, or otherwise interact with it (e.g., to update accounts). It may be the form of one or more computer apparatuses. A computer apparatus may comprise a processor and a computer readable medium.

A “supplier” can be an individual or an organization such as a business that is capable of providing goods or services. Exemplary suppliers may include legal services organizations, food service organizations, office supply organizations, etc. A supplier can operate one or more supplier devices. It can be a business partner of the buyer whose account payables are due.

A “supplier device” may include one or more devices operated by a supplier to initiate payment transactions and/or communicate with various systems and entities. In some embodiments, the supplier device may be a computer apparatus. The computer apparatus may comprise a processor and a computer readable medium. It may be a point of sale terminal or a virtual terminal that can be used to initiate a payment transaction and generate an authorization request message.

“Conditional control data” can include data which can control or limit the execution payment transactions associated with payment instructions. For example, in embodiments of the invention, conditional control data can include rules provided by a buyer, where the rules can set an upper limit on a transaction amount, or limit the transaction amount to an exact amount. When an authorization request message corresponding to a payment instruction is received by a server computer, the server computer can reply by indicating that the authorization request message is not authorized. Conditional control data can define or limit any particular characteristic of an approvable transaction including a transaction amount, a transaction time, a transaction location, a type of transaction, etc.

A “transaction message” is a message that is transmitted during a payment transaction process. A transaction message may be an authorization request message, authorization response message, clearance message, settlement message, and the like. A transaction message may contain information identifying the payment account associated with the transaction, including a primary account number, transaction identifier, expiration date, etc.

A “payment account” can be an account associated with a buyer for submitting payments to suppliers. An issuer may hold the payment account for the buyer, and the payment account may be used to conduct transactions. Suitable payment accounts include credit, debit, and prepaid card accounts which are issued by issuers. Such payment accounts may be linked to portable consumer devices such as credit, debit, or prepaid payment cards.

An “issuer” may be a business entity, bank, or other financial institution that maintains financial accounts and issues payment cards for a buyer. An “issuer computer” is a computer apparatus operated by an issuer.

An “acquirer” may be a bank, financial institution, or other entity (e.g., a bank with a supplier account). An “acquirer computer” is a server computer used by the acquirer.

An “authorization request message” may include a message, or sequence of messages, that requests an issuer of a payment account to authorize a transaction. An authorization request message according to an embodiment of the invention may comply with ISO (International Organization for Standardization) 8583, which is a standard for systems that exchange electronic transactions made by cardholders using payment cards. Authorization request messages may comprise an account number, a transaction amount, a CVV (card verification value), expiration date, service code, and other information.

A “settlement request message” may include a message, or sequence of messages, that initiates the clearance or settlement process. For example, a clearance process involves exchanging financial details between an acquirer and an issuer to facilitate posting a transaction to a buyer's account and reconciling each party's settlement position. Clearance and settlement can occur simultaneously or as separate processes.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

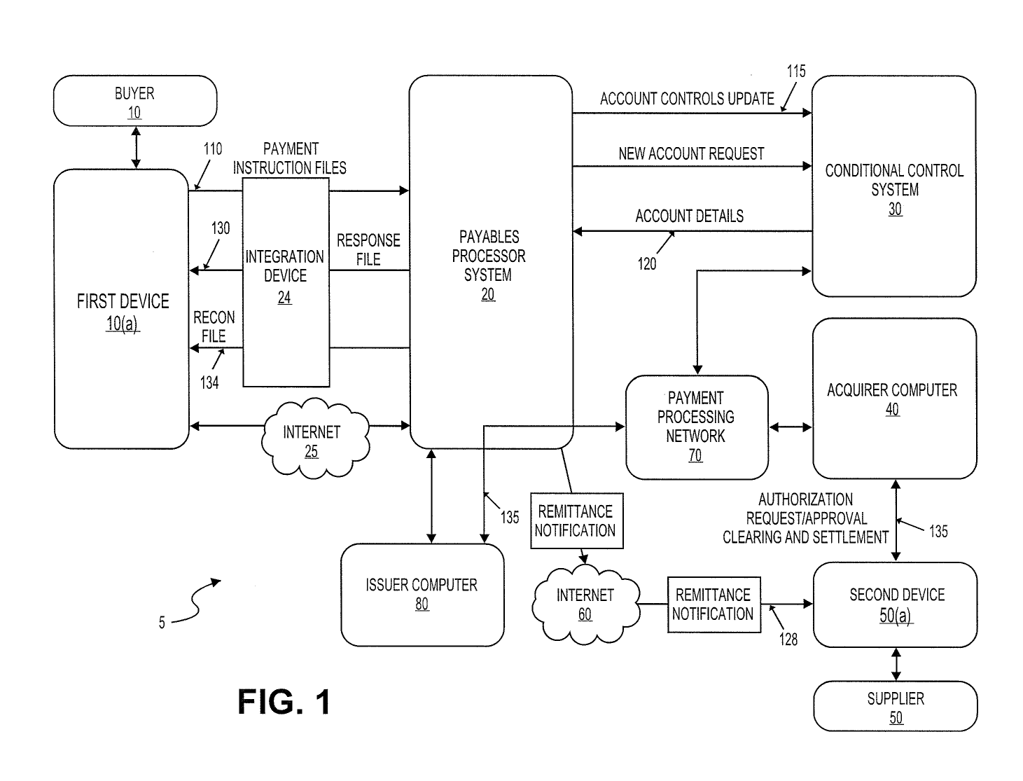

FIG. 1 shows a block diagram of a system according to an embodiment of the invention. For simplicity of illustration, one buyer, one acquirer, and one supplier are shown. It is understood however that embodiments of the invention may include multiple buyers, acquirers, and suppliers. The system 5 may include a buyer 10 that operates a first device 10(a), which may be a buyer device, and a supplier 50 that may operate a second device 50(a), which may be a supplier device such as a POS terminal.

A payables processor system 20 may reside between (in an operational sense), be in communication with, and/or be coupled to a payables processor system 20. The payables processor system 20 may in turn be in communication with a conditional control system 30 and a payment processing network 70. The second device 50(a) may communicate with the payables processor system 20 via a communication medium such as the Internet 60. The first device 10(a) may communicate with the payables processor system 20 via a communication medium such as the Internet 25 as well, and also via an integration device 24. The integration device 24 may be an optional computer apparatus that provides an interface between the payables processor system 20 and the first device 10(a). It may also convert data from one format to another so that it can be processed by the payables processor system 20.

The payment processing network 70 may reside between at least one issuer computer 80 and at least one acquirer computer 40. The payment processing network 70 may include data processing subsystems, networks, and operations used to support and deliver authorization services, exception file services, and clearing and settlement services. For example, the payment processing network 70 may comprise a server computer, coupled to a network interface (e.g. by an external communication interface), and a database(s) of information. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 70 may use any suitable wired or wireless network, including the Internet.

Although the payables processor system 20, the conditional control system 30, and the payment processing network 70 are shown as different boxes in FIG. 1, it is understood that any combination of these or all of these components may be combined in a single system. For example, any combination or all of the payables processor system 20, the conditional control system 30, and the payment processing system 70 may be embodied by a server computer.

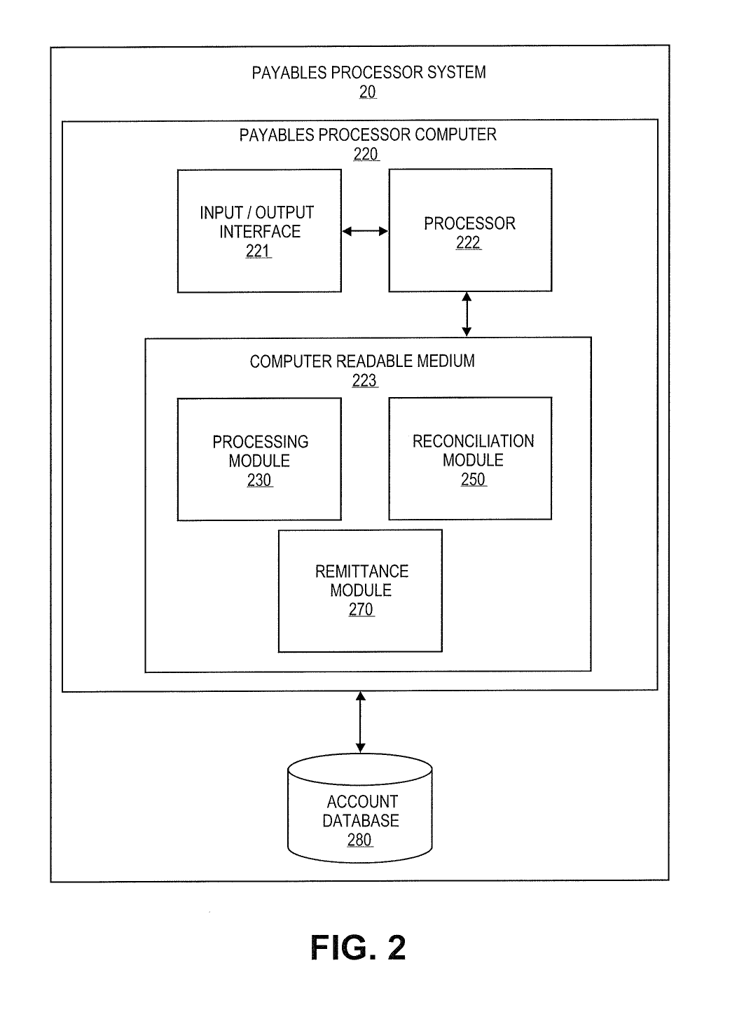

FIG. 2 shows a block diagram of a payables processor system 20, and some components that may be in the payables processor system 20. In some embodiments, the payable processor system 20 may comprise a payables processor computer 220. The payables processor computer 220 may comprise a processor 222, coupled to an input/output interface 221, and a computer readable medium 223.

The computer readable medium 223 may comprise a number of functional modules including a processing module 230, a reconciliation module 250, and a remittance module 270. For example, the processing module 230 may comprise code, executable by the processor 222 to process payment instructions received in a payment instruction file and communicate with buyer devices, a payment processing network, and a conditional control system. It may also provide an interface (e.g., a Web interface) for buyer devices. The reconciliation module 250 may generate reconciliation reports for buyers and/or suppliers. The remittance module 270 may prepare and cause the transmission of remittance notifications to suppliers, where the remittance notifications are based on payment instructions from buyers.

An account database 280 may be coupled to and may be in communication with the payables processor computer 220, and may store data for the buyers (e.g., preferences, account numbers, etc). The account database 280 may be accessed by the first device 10(a) via the Internet 25.

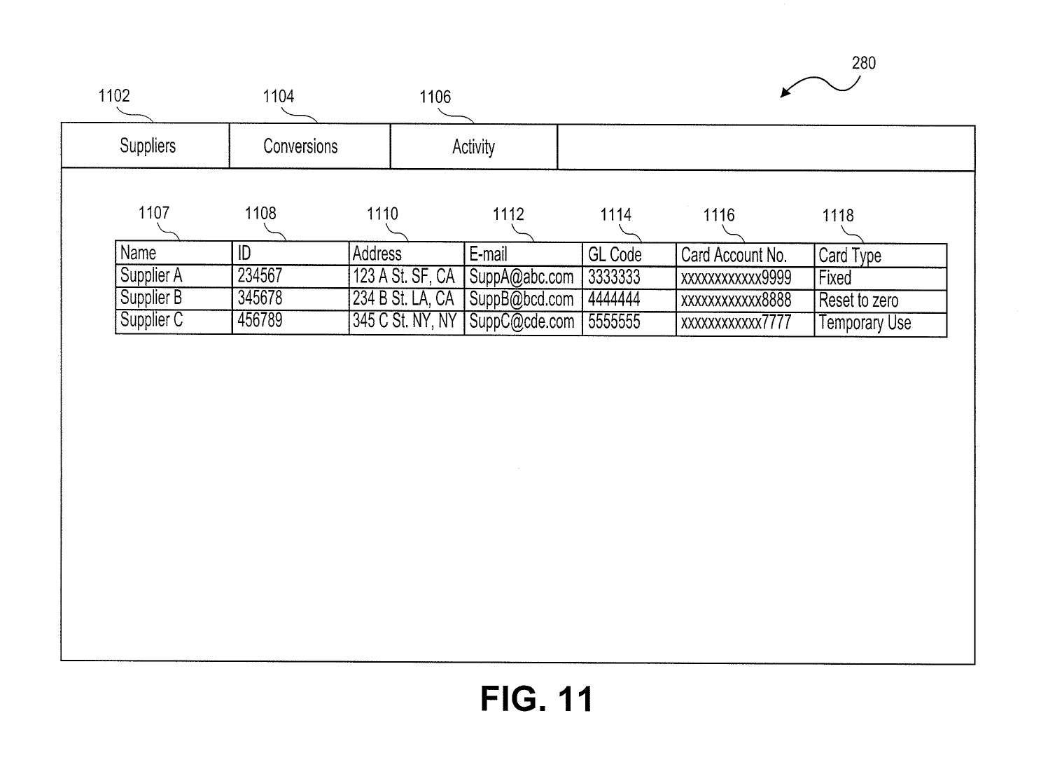

FIG. 11 shows a screenshot that a buyer may see when the buyer wants to manage payments to its suppliers. The account database 280 can store data such as the names of the suppliers 1107, identifiers for the suppliers 1108, addresses of the suppliers 1110, e-mail addresses or other contact information 1112, GL (general ledger) codes 1114, card account numbers that are used to pay the suppliers 1116, and a description of the card type 1118. Any of this data may be stored in the database 280. FIG. 11 also shows tabs to allow buyers to see the suppliers to be paid and data associated with them 1102, conversions 1104, and recent activity 1106. The conversions tab 1104 is intended to display other suppliers to the buyer that are also card (or account) acceptors and could potentially be enrolled into their payables program to take card payments. The listed suppliers would not be currently actively paid through the system.

As illustrated in FIG. 11, the buyer 10 may choose to use different types of payment account types for different suppliers, different transactions etc. In some cases, the buyer 10 may obtain and use a different account number for each transaction, or the buyer 10 could use one transaction account for each supplier that it pays. The former situation is more secure, since account numbers can only be used once. The latter situation is more convenient, since the same account number is used and the supplier does not have to look for a different account number for each transaction. In yet other embodiments, a single account number could be used for all suppliers and for all transactions. The accounts may be debit, credit, or prepaid account types as well.

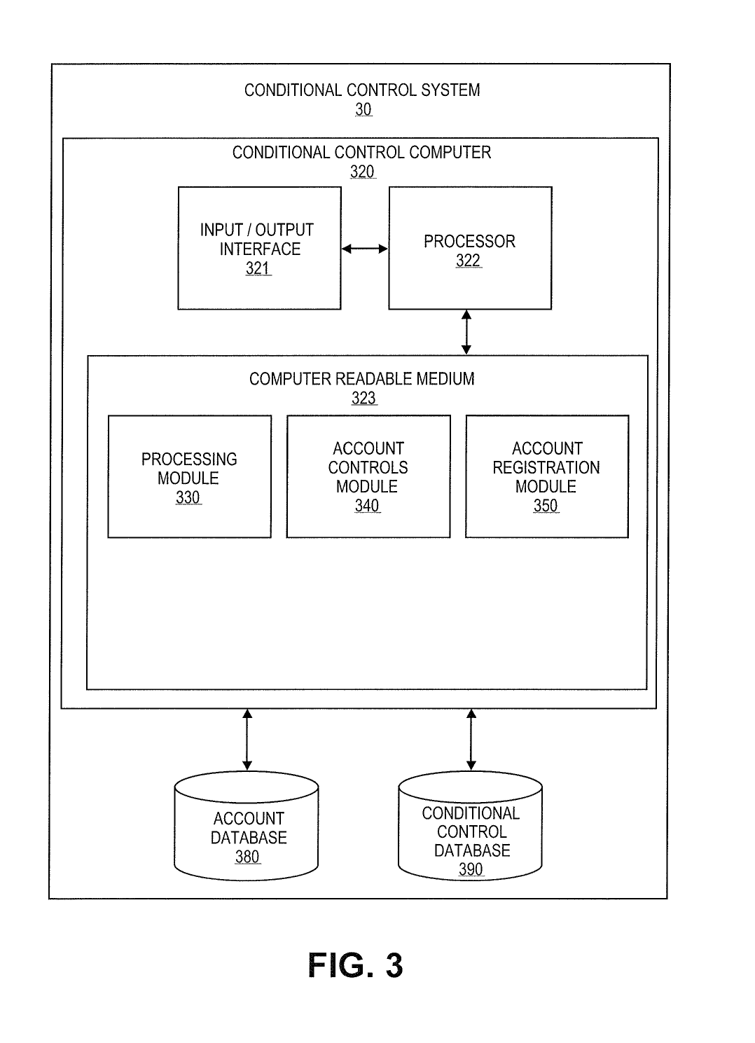

FIG. 3 shows a block diagram of a conditional control system 30. The conditional control system 30 may comprise a conditional control computer 320, which may comprise a processor 322, and an input/output interface 321 and a computer readable medium 323 coupled with the processor 322.

The computer readable medium 323 comprises a number of software modules including a processing module 330, an account controls module 340, and an account registration module 350. The processing module 330 can allow the conditional control computer 320 to communicate with the payables processor system 20 and the payment processing network 70. The account controls module 340 can receive and store control data in the conditional control database 390. The account registration module 350 can register new accounts that will use the conditional control system 30.

The conditional control computer 320 may be in communication with an account database 380 and a conditional control database 390. The account database 380 may store account information of the buyers (or suppliers). The conditional control database 390 may store conditional control data.

The conditional control system 30 can store conditional control data such as one or more authorization rules or conditional control flags on an individual account number that limit a payables transaction to exactly a set amount or an amount less than the set amount. This may be desirable to reduce the likelihood of problematic reconciliation issues and to avoid overcharging by the supplier.

Providing for conditional control data that sets an exact amount to be authorized for a payables transaction has a number of advantages. For example, a buyer may provide a payment instruction for $2,000 to the payables processor system to pay for a supplier invoice. The system can raise the limit of incoming transactions for the supplier to $2,000 and request that a supplier process the transaction for $2,000. The system may allow the supplier to submit an authorization request message for up to $2,000. However, if the supplier submits an authorization request message for $1,750, the buyer would be whole from a financial perspective, because the supplier has not been paid more than the payables amount. However, the transaction may have created a reconciliation problem and may cause the buyer to research the reason why the amount of the authorization request message does not match the suppliers invoice amount. Thus, in some embodiments, it may be desirable to limit the minimum payable amount in addition to the maximum payable amount in order to avoid reconciliation issues that may be created.

In some embodiments, the payables processor system 20, the conditional control system 30, and the payment processing network 70 may be embodied by a server computer. The server computer may comprise a processor, and a computer readable medium coupled to the processor. The computer readable medium comprises code for causing the processor to execute a method comprising receiving a payment instruction file where the payment instruction file contains one or more (e.g., a plurality) payment instructions to pay one or more suppliers, and conditional control data for the one or more payment instructions. The conditional control data controls execution of the payment instructions. The method also comprises receiving one or more of transaction messages corresponding to the one or more payment instructions, respectively, where each transaction message in the one or more transaction messages is conducted using one or more payment accounts, the one or more payment accounts held by one or more issuers. If transaction data in a transaction message in the one or more transaction messages does not satisfy the conditional control data for the payment instruction associated with the transaction message, then the transaction message is declined by the server computer. If the transaction data in the transaction message in the one or more transaction messages does satisfy the conditional control data for the payment instruction associated with the transaction message, then the transaction message is processed by the server computer.

Some methods may be described with reference to the prior system diagrams. One embodiment of the invention is directed to a method comprising receiving a payment instruction file at a server computer, where the payment instruction file contains one or more of payment instructions to pay one or more suppliers. The payment instruction file may also contain conditional control data for the one or more payment instructions. Alternatively, in other embodiments, the conditional control data may be supplied through another communication (e.g., an e-mail, Web session, etc.). The conditional control data controls execution of the payment instructions. The method also comprises receiving one or more transaction messages corresponding to the one or more payment instructions, respectively, where each transaction message in the one or more transaction messages is conducted using one or more payment accounts. The one or more payment accounts are held by one or more issuers. If transaction data in a transaction message in the one or more transaction messages does not satisfy the conditional control data for the payment instruction associated with the transaction message, then the transaction message is declined by the server computer. If transaction data in the transaction message in the one or more transaction messages does satisfy the conditional control data for the payment instruction associated with the transaction message, then the transaction message is processed by the server computer. The processing performed by the server computer may include forwarding the authorization request message to the issuer for final authorization, or authorizing the transaction. The processing performed by the server computer may include forwarding the authorization request message to the issuer for final authorization, or authorizing the transaction.

Referring to FIG. 1, at step 110, in one embodiment, at step 110, a buyer 10 will approve a number of invoices from the supplier 50 for payment. Using the first device 10(a), which may be a buyer device, the buyer 10 will submit a payment instruction file to a payables processor system 20. Prior to arriving at the integration device 24, the payment instruction file may be in a proprietary format, and the integration device 24 may convert the file into a standard EDI file.

The payment instruction file can contain a plurality of payment instructions to pay one or more suppliers, and conditional control data for the plurality of payment instructions, the conditional control data controlling execution of the payment instructions. For example, if the buyer approves of two payments to supplier A and supplier B, the payment instruction file might include a payment instruction for $50 to supplier A and a payment instruction for $100 to supplier B. Alternatively, both payment instructions may be to supplier A (e.g., $50 for one invoice, and $100 for another invoice issued by Supplier A). Table 1 shows exemplary data that may be contained in a payment instruction file.

TABLE 1

| Supplier/ | Invoice | | Conditional | Account Type/ |
|---|---|---|---|---|
| Supplier ID | No. | Amount | Control Data | Account Number |
| Supplier A/ | 3456 | $100 | Authorize if equal | Fixed - 2222 2222 |
| 234567 | | | to $100 | 2222 2222 |
| Supplier A/ | 4567 | $200 | Authorize if equal | Fixed - 2222 2222 |
| 234567 | | | to $200 | 2222 2222 |
| Supplier B/ | 5678 | $300 | Authorize if equal | Single Use |
| 345678 | | | to or less than | Determined by |
| | | | $300 | Payables |
| | | | | Processor System - |
| | | | | TBD |

At step 115, the payables processor system 20 can receive the payment instruction file and, transmit the conditional control data to the conditional control system 30. Examples of conditional control data are provided above, but examples may include specific authorized amounts for specific payment instructions and for specific payment account numbers.

At step 120, the conditional control system 30 can send account details (e.g., card account details) back to the payables processor system 20. Prior to, simultaneously, or after step 120, a response file is transmitted from the payables processor system 20 to the first device 10(a) via the integration device 24 (step 130).

At step 128, after the payment instruction file is received at the payables processor system 20, the payables processor system 20 can transmit a remittance notification to the supplier 50 to provide the supplier 50 with details on initiating the payment process. After receiving the remittance information, the supplier 50 can charge the buyer's account with the pre-approved payment amount. The remittance notification may comprise any suitable information including the account number of the buyer 10 or a token of the account number of the buyer 10.

In some embodiments, if the supplier has a card account on file to process the payment, the remittance may include the last 4 digits of the card account number. If instead the supplier is being paid with a single-use account, the supplier can be provided with a URL where they can retrieve the card account number to take payment after being authenticated.

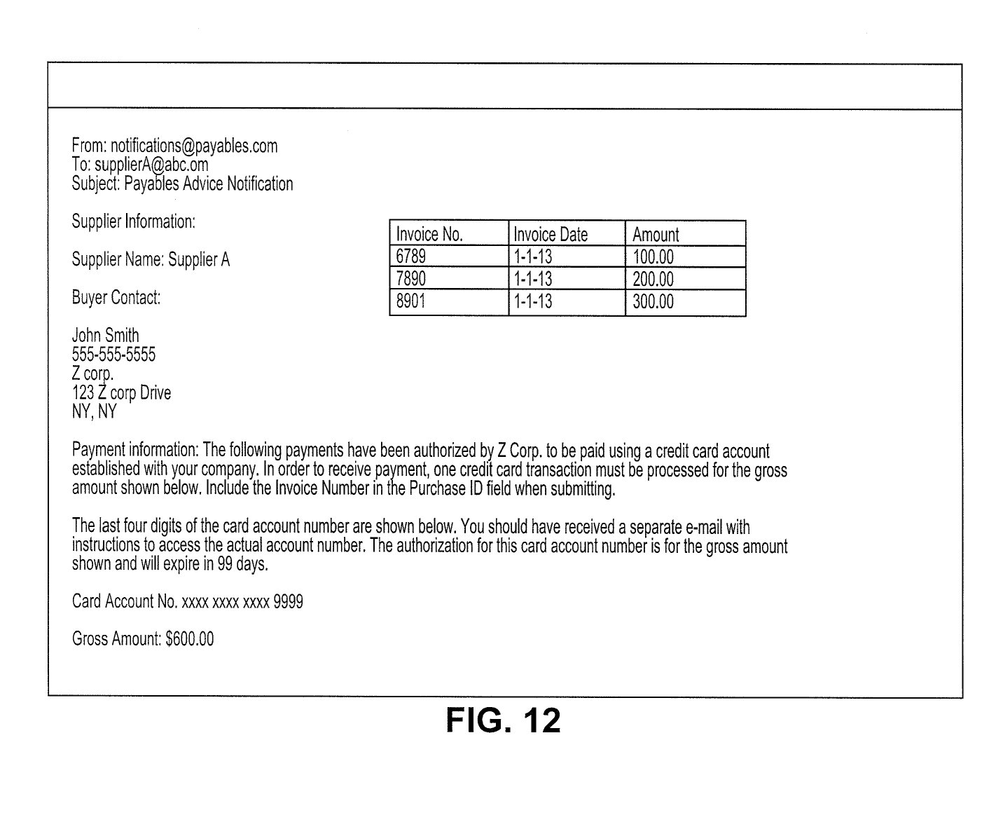

An exemplary remittance notification in the form of an e-mail message is shown in FIG. 12. As shown, there are three invoice numbers and three payment amounts that are authorized by the buyer. In order to receive payment, the seller can to follow the instructions in the notification.

After the supplier 50 receives the remittance notification, the supplier 50 initiates the payment transaction with the received account number. The supplier 50 can enter the required payment data into the second device 50(a) to cause it to generate an authorization request message. Once the authorization request message is generated by the second device 50(a), it is transmitted to the acquirer computer 40, to the payment processing network 70, and then to the issuer computer 80 (see step 135).

Before the authorization request message is transmitted to the issuer computer 80 by the payment processing network 70, however, the payment processing network 70 may provide the transaction data in the authorization request message to the conditional control system 30 to determine if the transaction data in the authorization request message is consistent with the conditional control data associated with the payment instruction linked to the authorization request message. In other embodiments, the conditional control data may be retrieved from the conditional control system 30 or may have been previously provided to the payment processing network 70 by the conditional control system 30. If the transaction data in the authorization request message does not satisfy the conditional control data, then the transaction is denied and an authorization response message may be sent to the second device 50(a) via the acquirer computer 40. If the transaction data in the authorization request message does satisfy the conditional control data, then the transaction is temporarily authorized and the authorization request message is transmitted to the issuer computer 80.

The issuer of the issuer computer 80 then approves of the authorization request message, and generates an authorization response message. The authorization response message is then transmitted from the issuer computer 80 to the payment processing network 70, to the acquirer computer 40, and to the second device 50(a).

After the authorization process is complete, a clearing and settlement process is performed. Clearing messages may be sent from the acquirer computer to the issuer computer 80 via the payment processing network 70. If the transaction data was not previously subjected to the conditional control data, the conditional control data could be applied during the transmission of the clearing messages.

After payment is complete, a reconciliation file (step 134) may be transmitted from the payables processor system 20 to the first device 10(a). The reconciliation file may be in the form of a Microsoft Excel® or CSV file format. They may be delivered daily, weekly, bi-weekly, etc.

In some embodiments, the conditional control system 30 may automatically delete conditional control data when a matching transaction is authorized by the payment processing network 70. In other embodiments, the system 5 may allow the user (e.g., the buyer 10) to delete conditional control data by submitting a request to the payables processor system 20 or the conditional control system 30 when a matching transaction is authorized. In an embodiment, the system 5 can support real-time transaction control and batch transaction control interactions at bank and company level on the payables processor system 20 and the conditional control system 30.

Embodiments of the invention may provide a number of other advantages over the existing systems. Users may interact directly with an interface in a payables processor system that includes transaction control and alerts. The system can store one or more conditional controls at an account level, or even a bank (e.g., issuer) and company level (e.g., supplier). The system can enable single amount transaction control for an account with the flexibility of supporting multiple amounts transaction controls.

Additionally, the system can support real-time transaction control and batch transaction control interactions from the payables processor with conditional control. The user or other entities might have the ability to view audit logs for any interaction that occurs between the payables processor system and the conditional control system during the payment process and reconciliation life cycle. The user may also have the ability to view and update one or more conditional controls for a card account in the payables processor system.

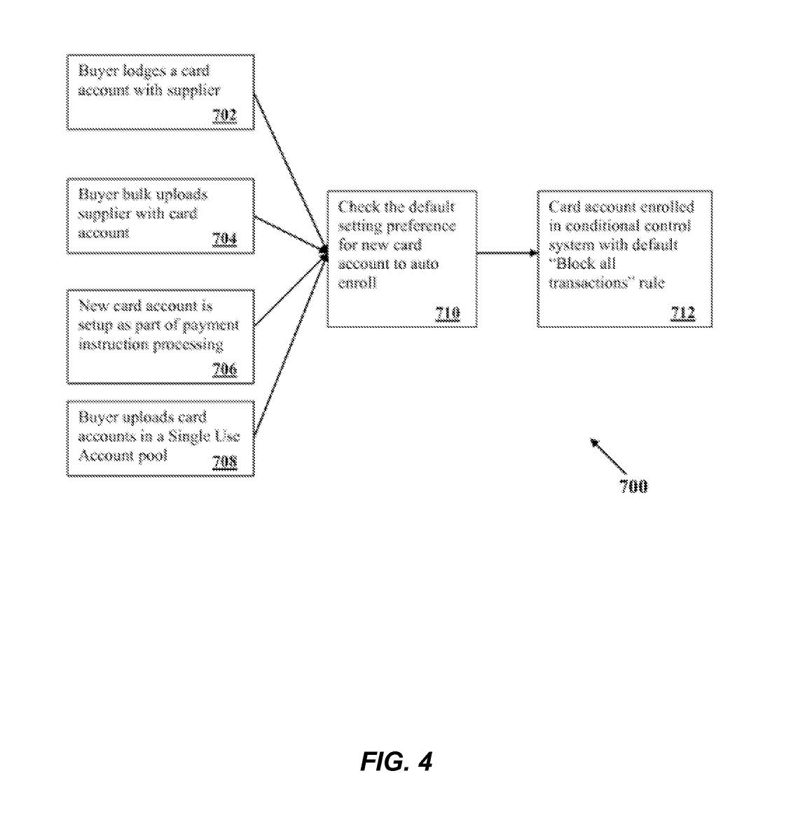

FIG. 4 shows a flowchart showing different ways to enroll account numbers in a conditional control system. Embodiments of the invention can also support multiple usage models. For example, the system can support “single use account model” (SUA) which may provide a one-to-one relationship between an account and a payment, or a “lodged account model” which may provide a one-to-one relationship between an account and a buyer's supplier. In an embodiment of the lodged account model, the buyer may share a first primary account number with a first supplier, and a second primary account number with a second supplier, so that the supplier will use the account number for a particular buyer, and a new account number will not be transmitted for each instruction file between the buyer and supplier. Further details regarding the some of the account usage models that can be used in the above-described system can be found in U.S. Patent Publication No. 2011055079 to Meaney et al., which is herein incorporated by reference in its entirety for all purposes.

The method 700 may begin by providing payment account numbers to the payables processor system and/or the conditional control system. This can be done at any suitable time. For example, this can be done when a buyer submits a payment request or sets up a new account. As shown in FIG. 4, the buyer may lodge a card account with a supplier 702, bulk upload supplier data (e.g., names and addresses of suppliers) with one or more payment accounts 704, set up a new card account as part of a payment instruction processing 706 when payment instructions are submitted by the buyer, or upload an account into a SUA (Single Use Account) pool 708 (described above).

Next, in step 710, the method checks whether to auto enroll the new account in the conditional control system by default. If so, in step 712, the method enrolls the card account in the conditional control system with the default “block all transactions” rule. In an embodiment of the invention, the method may set up a different default rule or automatically enroll the new account into various other systems. As described above, after the conditional controls data is received by the conditional control system from the buyer, the transaction rules may change.

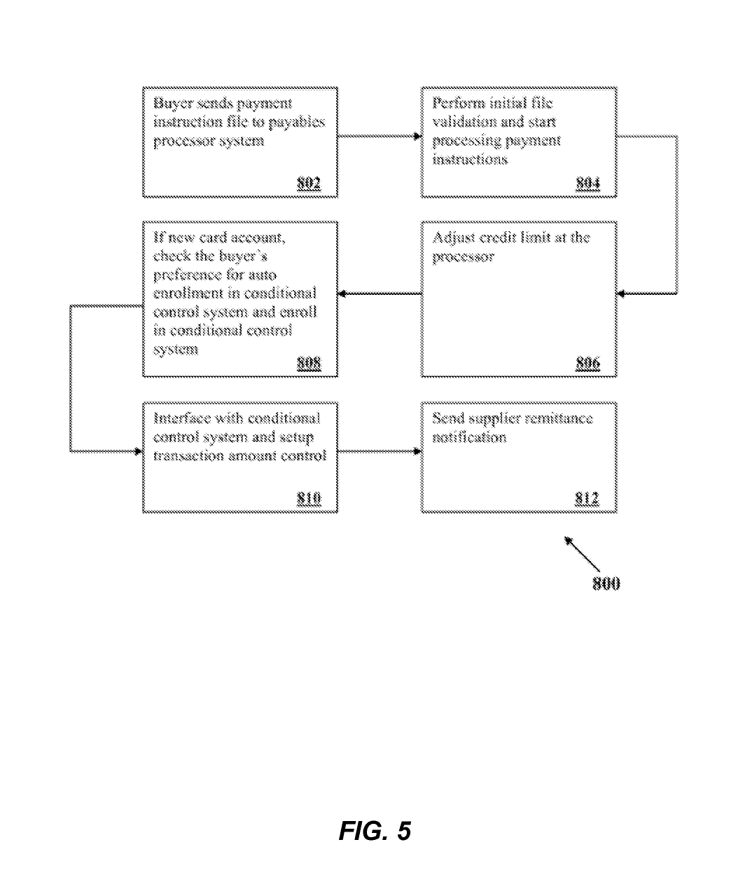

FIG. 5 shows a flowchart for processing a buyer's instruction file according to an embodiment of the invention. The method 800 may begin at step 802 when a buyer sends a payment instruction file to the payables processor system. At step 804, the payables processor system may perform an initial file validation and starts processing the payment instructions. Next, at step 806, the method may adjust the credit limit at the processor within the payables processor system. If this is a new card account, the method at step 808 may check the buyer's preference for automatic enrollment in the conditional control system and enroll the new account in the conditional control system. At step 810, the method may interface with the conditional control system and set up transaction amount control. Next, the method may send the supplier remittance notification at step 812.

In embodiments of the invention, the user may set up multiple conditional controls on one account for one supplier so that multiple controls can be set on the same card. The user can set up the multiple conditional controls automatically or allow a single amount transaction control with the flexibility of supporting multiple amounts transaction control for a card account in the payables processor system. Further, the user can allow multiple limit amounts on one payables processor account for one business or supplier that accepts multiple limit amounts.

By allowing a buyer to approve of several payables with the same supplier, the system can be more functional for payables to business entities that provide several services to other business entities in one time frame (i.e. billing cycle). Further, the rationale for having multiple amounts with one supplier might be to assist a buyer in settling debts when they receive multiple invoices from a particular supplier in a billing cycle. The method may allow the buyer to set up multiple payment instructions with the merchant through the use of conditional controls and a payables processor system. This way, one card account may be lodged for a supplier and the system might block any payment on the card other than the amounts foreseen.

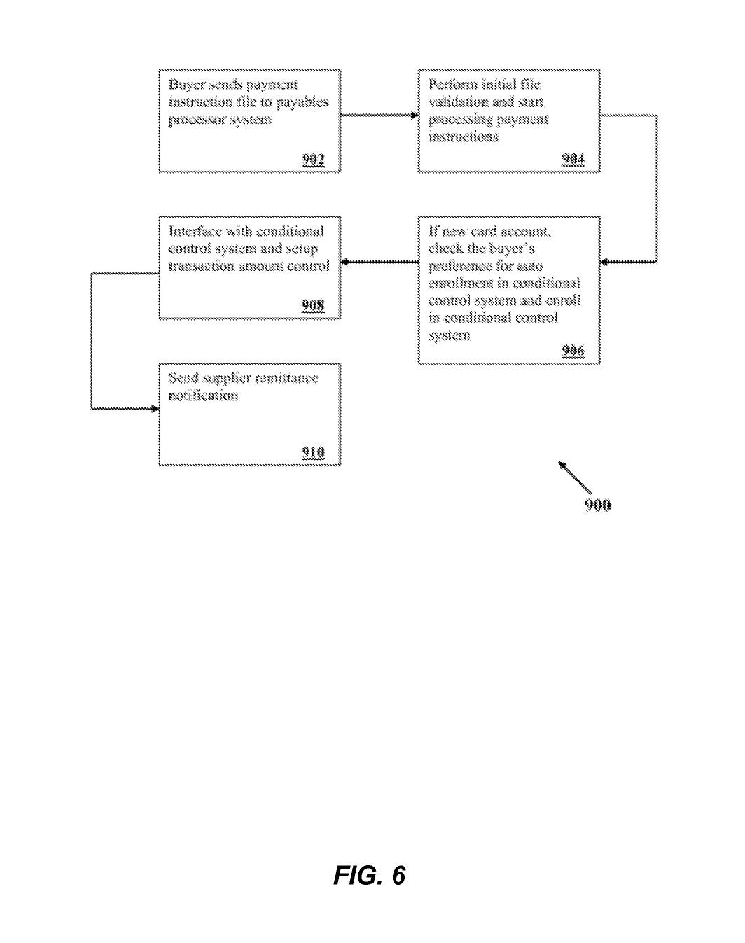

FIG. 6 shows a flowchart for processing a buyer's instruction file according to an embodiment of the invention. In this embodiment, there is no credit limit adjustment step as in the method described with reference to FIG. 5. The method 900 can begin with a buyer sending a payment instruction file to the payables processor system at step 902. At step 904, the method can perform an initial file validation and start processing payment instructions. If this is a new card account, the method at step 906 may check the buyer's preference for automatic enrollment in the conditional control system and enroll the new account in the conditional control system. Next, at step 908, the method may interface with the conditional control system and set up a transaction amount control. At step 910, the method can send the supplier remittance notification. In an embodiment of the invention, a processor, other devices, or human interactions may complete the aforementioned steps.

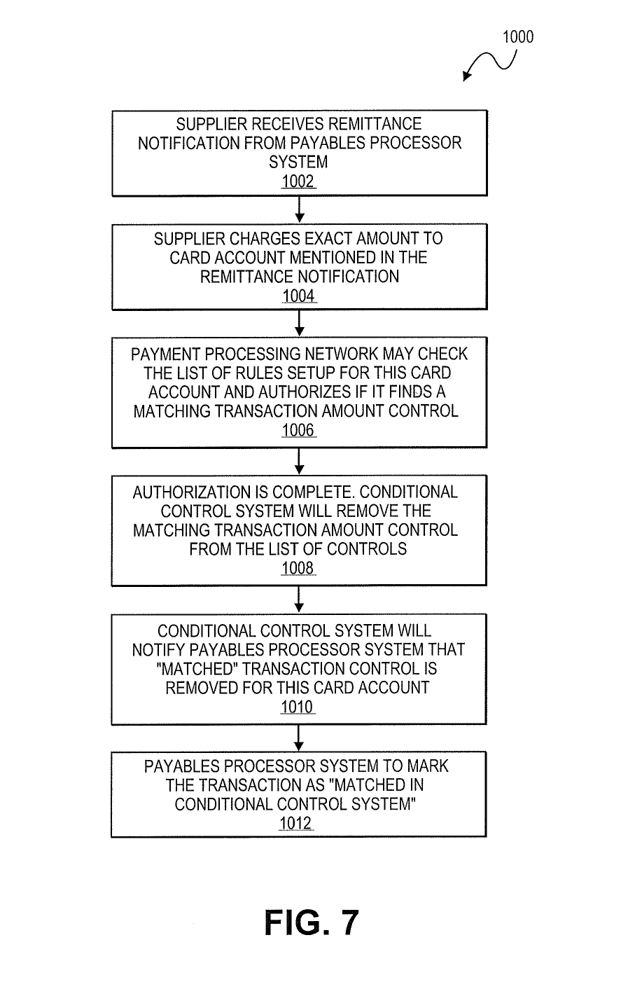

FIG. 7 shows a flowchart of a supplier's interaction with the payables processor system after receiving a remittance notification. The method 1000 may begin with step 1002 when a supplier receives remittance notification from the payables processor system. At step 1004, the supplier charges an exact amount to the account mentioned in a remittance notification. At step 1006, the payment processing network may check the list of rules set up for an account and authorize the transaction if it finds a matching conditional control in a list of conditional control rules. At step 1008, the authorization may be complete. The conditional control system may remove the matching transaction amount control from the list of controls. Next, at step 1010, the conditional control system may notify the payables processor system that the “matched” transaction control is removed for this card account. At step 1012, the payables processor can mark the transaction as “matched in the conditional control system.” If there are no remaining transaction control rules, the conditional control system can re-apply the default “block all transactions” rule to the card account.

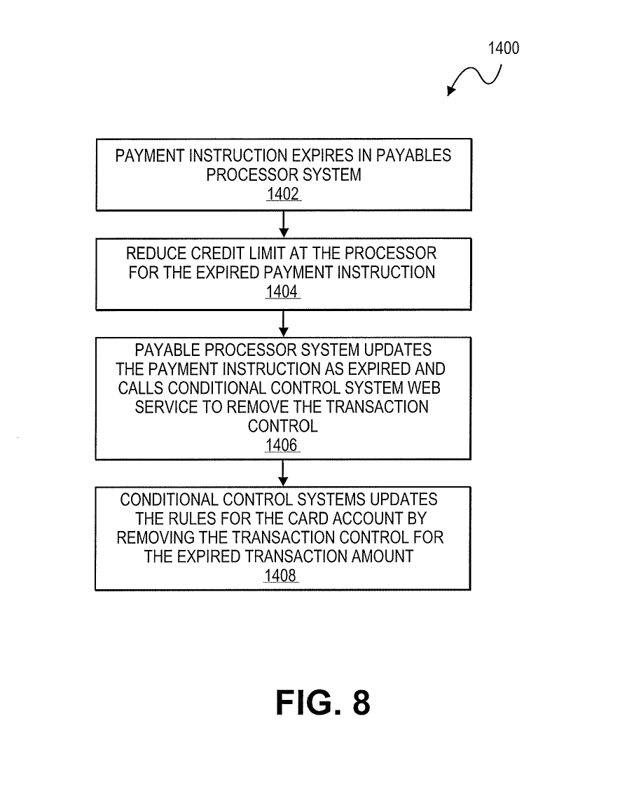

FIG. 8 shows a flowchart of the payables processor system after a payment instruction expires according to an embodiment of the invention. The method 1400 can begin at step 1402 when the payment instruction expires in the payables processor system. This may be due to a number of reasons. For instance, even though the supplier received a remittance notification as noted above, the supplier may not have taken the actual step of initiating the payment process. At step 1404, the payables processor system may reduce the credit limit at the processor for the expired payment instruction. Next, at step 1406, the payables processor system may update the payment instruction as expired and call the conditional control web service to remove the transaction control. At step 1408, the conditional control system may update the rules for the card account by removing the transaction control for the expired transaction amount. If there are no remaining transaction control rules, the conditional control system will re-apply the default “block all transactions” rule to the card account.

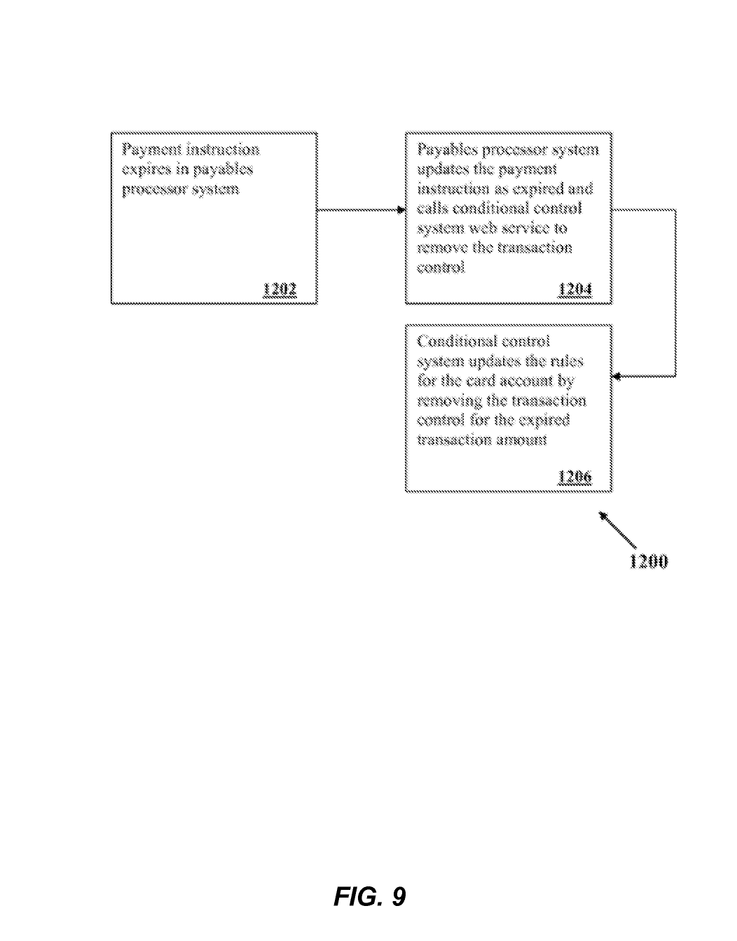

FIG. 9 shows a flowchart of the payables processor system after a payment instruction expires according to an embodiment of the invention. The method 1200 can begin at step 1202 when the payment instruction expires in the payables processor system. This may be due to a number of reasons. For instance, even though the supplier received a remittance notification as noted above, the supplier may not have taken the actual step of initiating the payment process. At step 1204, the payables processor may update the payment instruction as expired and call the conditional control web service to remove the transaction control. At step 1206, the conditional control system can update rules for the card account by removing the transaction control for the expired transaction amount. If there are no remaining transaction control rules, the conditional control system will re-apply the default “block all transactions” rule to the card account. Further, the web service can support removal of a card from the service.

The various participants and elements described herein may operate one or more computer apparatuses to facilitate the functions described herein. Any of the elements in the above-described Figures, including any servers or databases, may use any suitable number of subsystems to facilitate the functions described herein.

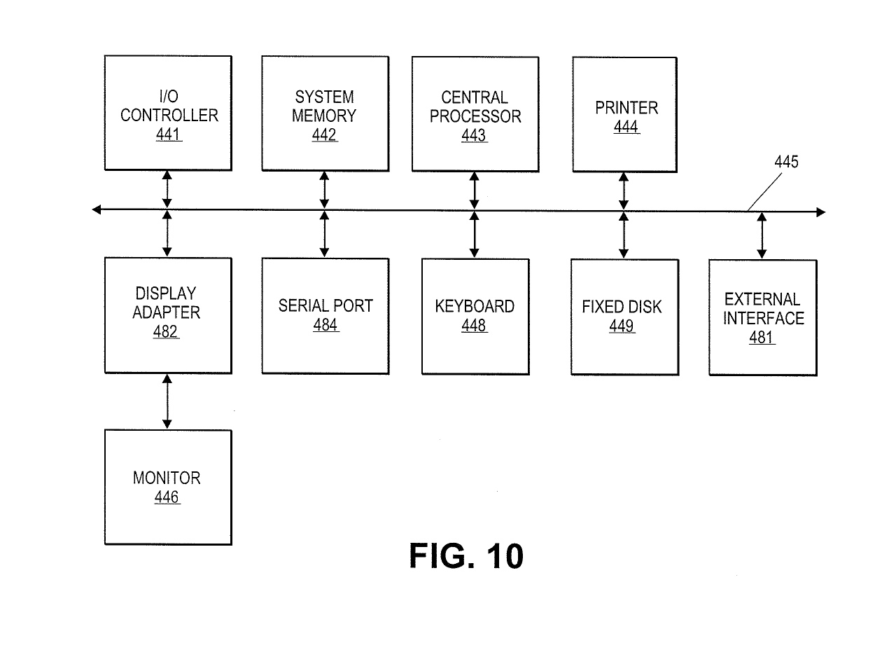

Examples of such subsystems or components are shown in FIG. 10. The subsystems shown in FIG. 10 are interconnected via a system bus 445. Additional subsystems such as a printer 444, keyboard 448, fixed disk 449 (or other memory comprising computer readable media), monitor 446, which is coupled to display adapter 482, and others are shown. Peripherals and input/output (I/O) devices, which couple to I/O controller 441 (which can be a processor or other suitable controller), can be connected to the computer system by any number of means known in the art, such as serial port 484. For example, serial port 484 or external interface 481 can be used to connect the computer apparatus to a wide area network such as the Internet, a mouse input device, or a scanner. The interconnection via system bus allows the central processor 443 to communicate with each subsystem and to control the execution of instructions from system memory 442 or the fixed disk 449, as well as the exchange of information between subsystems. The system memory 442 and/or the fixed disk 449 may embody a computer readable medium.

A number of other embodiments are also possible. For example, in some embodiments, a supplier may have the ability to provide conditional control data to the conditional control system. The supplier may wish to control the payment process such that it is paid exactly what it expects to receive. This may be done in order to ensure that the supplier's invoices match the payments received. For example, the suppler may send two invoices to the buyer in one week, one for $10,000 and one for $20,000. The supplier can set a rule to ensure the two payments for $10,000 and $20,000 are processed, instead of one payment for $30,000.

In some embodiments, the buyer can choose not to enforce the conditional controls on a supplier who may have a need to take payments in amounts other than what may have been defined in the payment instruction. In these scenarios, the supplier is able to take payments in any amounts up to the credit limit available on the card.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving a payment instruction file, wherein the payment instruction file contains one or more payment instructions to pay one or more suppliers, and conditional control data for the one or more payment instructions, the conditional control data controlling execution of the payment instructions;
receiving one or more transaction messages corresponding to the one or more payment instructions, respectively, wherein each transaction message in the one or more transaction messages is conducted using one or more payment accounts, the one or more payment accounts held by one or more issuers;
if transaction data in a transaction message in the one or more transaction messages does not satisfy the conditional control data for the payment instruction associated with the transaction message, then declining the transaction message by a server computer; and
if transaction data in the transaction message in the one or more transaction messages does satisfy the conditional control data for the payment instruction associated with the transaction message, then processing the transaction message by the server computer.

2. The method of claim 1, wherein the transaction message is an authorization request message and wherein processing the transaction message comprises transmitting the authorization request message to the issuer associated with the payment account that is associated with the authorization request message.

3. The method of claim 1, wherein the transaction message is a settlement request message and wherein processing the transaction message comprises transmitting the settlement request message to the issuer associated with the payment account that is associated with the settlement request message.

4. The method of claim 1, wherein the supplier initiates the transaction message through a supplier device, the supplier device being a point of sale terminal or a virtual terminal.

5. The method of claim 1, wherein the payment instruction file is received from a buyer device, and wherein the server computer is in a payables processor system.

6. The method of claim 1, wherein the conditional control data for the payment instruction sets an upper limit on a transaction amount associated with a transaction message corresponding to the payment instruction, and wherein the server computer processes the transaction message if the transaction amount is below or equal to the upper limit and denies the transaction message if the amount is above the upper limit.

7. The method of claim 1, wherein the conditional control data for the payment instruction sets an exact amount for a transaction amount associated with a transaction message corresponding to the payment instruction, and wherein the server computer processes the transaction message if the transaction amount is equal to the exact amount and denies the transaction message if the amount in the transaction message is not equal to the exact amount.

8. The method of claim 1, wherein the conditional control data is received at the server computer in a communication separate from the payment instruction file.

9. A server computer comprising:
a processor, and
a computer readable medium coupled to the processor, the computer readable medium comprising code for causing the processor to execute a method comprising:
receiving a payment instruction file, wherein the payment instruction file contains one or more payment instructions to pay one or more suppliers, and conditional control data for the one or more payment instructions, the conditional control data controlling execution of the payment instructions;
receiving one or more transaction messages corresponding to the one or more payment instructions, respectively, wherein each transaction message in the one or more transaction messages is conducted using one or more payment accounts, the one or more payment accounts held by one or more issuers;
if transaction data in a transaction message in the one or more transaction messages does not satisfy the conditional control data for the payment instruction associated with the transaction message, then declining the transaction message by the server computer;
if transaction data in the transaction message in the one or more of transaction messages does satisfy the conditional control data for the payment instruction associated with the transaction message, then processing the transaction message by the server computer.

10. The server computer of claim 9, wherein the transaction message is an authorization request message and wherein processing the transaction message comprises transmitting the authorization request message to the issuer associated with the payment account that is associated with the authorization request message.

11. The server computer of claim 9, wherein the transaction message is a settlement request message and wherein processing the transaction message comprises transmitting the settlement request message to the issuer associated with the payment account that is associated with the settlement request message.

12. The server computer of claim 9, wherein the supplier initiates the transaction message through a supplier device, the supplier device being a point of sale terminal or a virtual terminal.

13. The server computer of claim 9, wherein the payment instruction file is received from a buyer device, and wherein the server computer is in a payables processor system.

14. The server computer of claim 9, wherein the conditional control data for the payment instruction sets an upper limit on a transaction amount associated with a transaction message corresponding to the payment instruction, and wherein the server computer processes the transaction message if the transaction amount is below or equal to the upper limit and denies the transaction message if the amount is above the upper limit.

15. The server computer of claim 9, wherein the conditional control data for the payment instruction sets an exact amount for a transaction amount associated with a transaction message corresponding to the payment instruction, and wherein the server computer processes the transaction message if the transaction amount is equal to the exact amount and denies the transaction message if the amount in the transaction message is not equal to the exact amount.

16. The server computer of claim 9, wherein the conditional control data is received at the server computer in the payment instruction file.

17. A method comprising:
receiving, by a supplier device, a plurality of remittance messages from a server computer corresponding to a plurality of payment instructions from a buyer;
transmitting, by the supplier device, a plurality of transaction messages corresponding to the plurality of payment instructions to the server computer, respectively, wherein each transaction message in the plurality of transaction messages is conducted using one or more payment accounts, the one or more payment accounts held by one or more issuers;
if transaction data in a transaction message in the one or more transaction messages does not satisfy the conditional control data for the payment instruction associated with the transaction message, then declining the transaction message by the server computer; and
if transaction data in the transaction message in the one or more transaction messages does satisfy the conditional control data for the payment instruction associated with the transaction message, then processing the transaction message by the server computer.

18. The method of claim 17, wherein the supplier device is a point of sale terminal or a virtual terminal.

19. The method of claim 17, wherein the transaction message is an authorization request message and wherein processing the transaction message comprises transmitting the authorization request message to the issuer associated with the payment account that is associated with the authorization request message.

20. The method of claim 17, wherein the conditional control data for the payment instruction sets an exact amount for a transaction amount associated with a transaction message corresponding to the payment instruction, and wherein the server computer processes the transaction message if the transaction amount is equal to the exact amount and denies the transaction message if the amount in the transaction message is not equal to the exact amount.
